(19) United States
(12) Patent Application Publication
(10) Pub. No.: US 2004/0128258 A1
(43) Pub. Date: Jul. 1, 2004

(54) Card certification and authorization system and method thereof

(76) Inventor: Min-Chieh Su, Taipei (TW)

Correspondence Address: BIRCH STEWART KOLASCH & BIRCH, PO BOX 747, FALLS CHURCH, VA, 22040-0747, US

(21) Appl. No.: 10/704,627

(22) Filed: Nov. 12, 2003

(30) Foreign Application Priority Data
Dec. 26, 2002 (TW) 91137545

(51) Int. Cl. G06F 17/60

(52) U.S. Cl. 705/67

(57) ABSTRACT

A card certification and authorization system and method is disclosed. When a cardholder swipes a card at any terminal device and initiates the process of authorization, the data storage management system executes instantaneous bidirectional comparisons of the encoding data. It reduces the risk produced by the unidirectional certification and authentication. When the comparisons succeed and authorization is allowed, the encoding system can instantly produces new coding data randomly to be used as stored record to illuminates the chance of the card information being stolen. When the comparisons fail and authorization is denied, the data storage management system will put the account on hold and start the notification process using the terminal device, which decreases the chance of the card being used without authorization. The comparisons of the encoding data and the process of storing data need to be converted using conversion and encryption program to ensure data safety.

### BACKGROUND OF THE INVENTION

### FIELD OF INVENTION

The invention relates to the system and the method of authorization, especially applied to card authorization.

Previous Technology

The current card certification and authorization system is used in areas as: electronic transaction security, production control, entrance/access control, internet login identification, database login identification and personal identification. All these areas have their own unique methods for performing a certification and authorization process. After in-depth researches and comparisons, all these methods have a common problem with using a single systematic process to compare the certification codes and a unidirectional model for certifications. This system and method for certification and authorization bring a safety threat and risky for cardholders after a period of time.

The financial industry is mostly affected by this problem. The most widely used plastic currency are credit cards and debit cards. These cards usually only use a single systematic encoding method for certification and authorization. Even the authorization code assigned by card issuing banks uses a single systematic certification process. It is not only easily cracked and recorded, but can also cause large damage to the card's issuing bank when cardholders' personal and credit information is exposed to the public, or when they use the cards incorrectly.

Even though there are new ways to prevent these card frauds by combining memory chips to the cards to store identity information, including personal biometrics such as: fingerprints, pictures, voice recognition and iris signatures, these new ways still follow the traditional certification and authorization process and the method of a single systematic certification and unidirectional authorization. Although these biometrics are much more difficult to crack and/or duplicate, it is not impossible to do so. Machines can duplicate fingerprints and scanners can also reproduce iris signatures. It is also very costly to incorporate peripherals to provide the functions of verifying biological distinctions; it is difficult to apply them widely to practical everyday uses. Faced with a variety of certified card authentication systems and methods, the related beneficiaries, such as the cardholders and the card issuers, are all hoping for an effective prevention method to protect the safety of everyone involved, and the systems.

### SUMMARY OF THE INVENTION

To solve the authentication problem, this invention provides a brand new system and method for card certification and authorization. The main difference between the invention and the current technology is that the invention uses an immediate bi-directional certification and a local random encoding method to control every step of the authentication process, from the time when the cards are swept to the time when the card authorization data are stored by the card issuers.

The immediate bidirectional comparison of the encoding data decreases the risks, produced by the unidirectional and single certification and authorization process, to the cardholders and issuers. It also uses an unbiased third party encoding device to produce encoding data locally and prevents unauthorized use of the card and database information and the chances to reproduce them. When abnormality is detected and authorization is denied, the invention puts the card account on ‘hold instantly’, and sends notifications to reject illegal and unauthorized use of the card. As for the storing of the encoding data, to prevent internal security defect, the invention provides a special code conversion and encryption process to keep the data safe. Using the method above, it is possible to provide a complete certification and authorization process, and use it every day without costly peripherals.

To achieve these goals, the certification and authorization system includes the following components: card, terminal device, data storage management system and encoding device.

The method of the invention for card certification and authorization includes the following steps: first, use the terminal device to retrieve the certification data stored in the card, transmit the certification data to the data storage management system, and then start an identifying process of the certification data by the data storage management system the comparing and authenticating process. If the identifying processes are successful, the encoding device starts the encoding process. Using the data storage management system and the terminal device, the record storing process can be executed and then completes the authorization procedure.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1a is the block diagram of the system and method for certification and authorization of the prior art;

FIG. 1b is the schematic block diagram of the system and method for certification and authorization of the prior art showing the operation of the system;

FIG. 2a is the block diagram of the system and method for certification and authorization of the invention;

FIG. 2b is the schematic block diagram of the system and method for certification and authorization of the invention showing the operation of the system;

FIG. 2c is another schematic block diagram of the system and method for certification and authorization of the invention showing the operation of the system;

FIG. 2d is the schematic block diagram of the system and method for certification and authorization of the invention showing the operation of the system;

FIG. 3a is the flow chart of the system and method for certification and authorization of the invention showing the operation of the system;

FIG. 3b is the flow chart of certification identifying process of the system of the invention;

FIG. 3c is the flow chart of encoding process of the system of the invention;

FIGS. 3d and 3e is the flow chart of record storing process of the system of the invention;

FIG. 4 is the schematic diagram of recovering and encrypting process of the system of the invention; and

FIG. 5 is the schematic diagram of bi-direction certification identifying process of the encoding data of the system of the invention.

### DETAILED DESCRIPTION OF THE INVENTION

The invention is related to the system and method for card certification and authorization. When the cardholder 15 takes the card 10 to terminal device 20 in the card-swiping device 25 for the authorization process, through bi-directionally comparing 30 the card 10 and the stored encoding data in the database via the card issuer 35's data storage management system, the authorization process is completed safely.

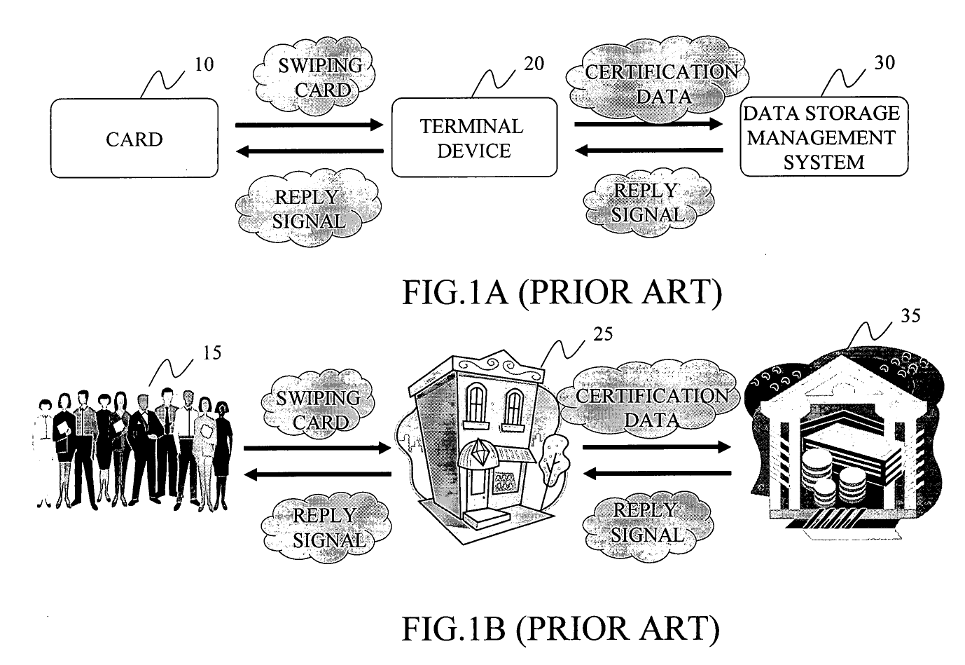

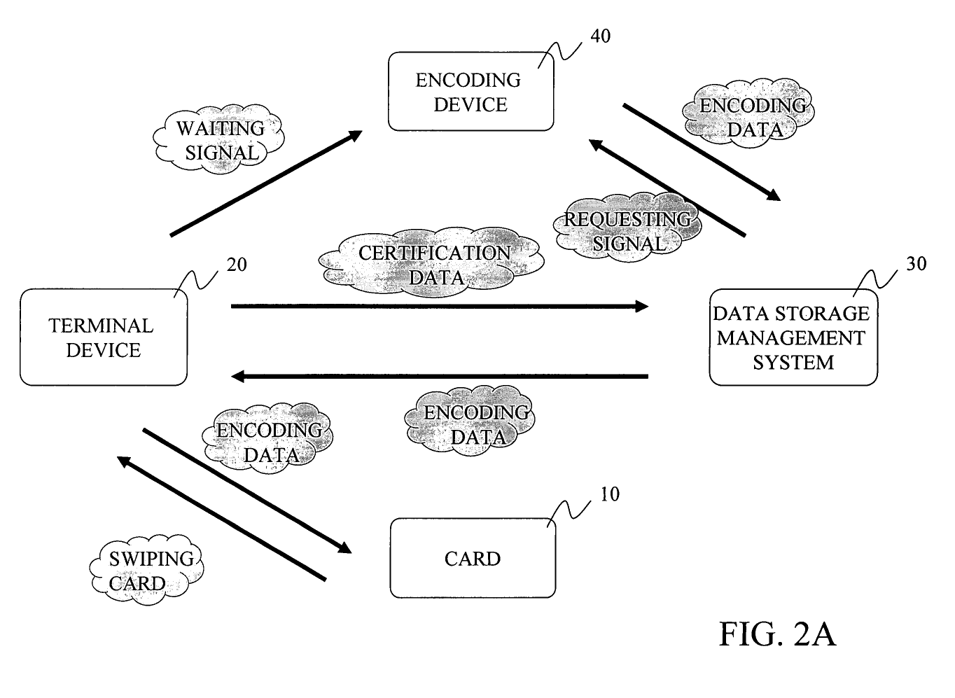

The main difference between this invention and the prior art is that the systems of the prior art use a single systematic certification and a unidirectional certifying process, as shown in FIGS. 1a and 1b. The cardholder 15 takes the card 10 to the card-swiping device 25 and swipes the card. The terminal device 20 retrieves the stored certification information, such as the PIN number, from the card 10 and transmits it to the card issuer 35's data storage management system 30. The data storage management system 30 compares the certification information with the stored data in the database. If the information is correct, it then produces a replying signal, such as the authorization number, back to the terminal device 20. Finally, the terminal device 20 accepts the card 10's authorization and completes the process.

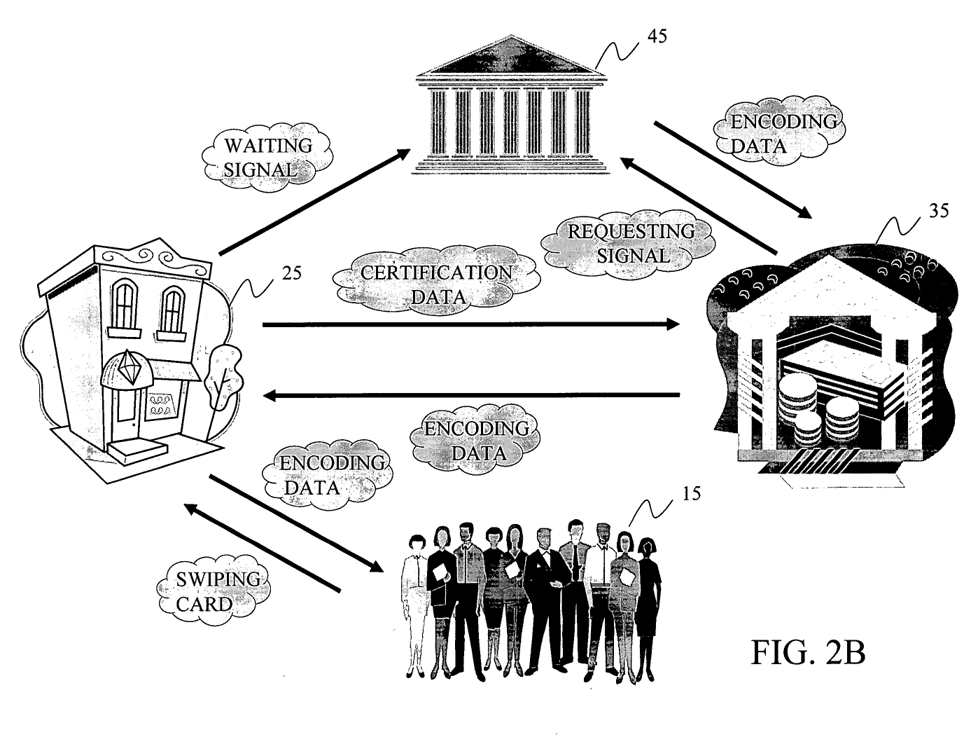

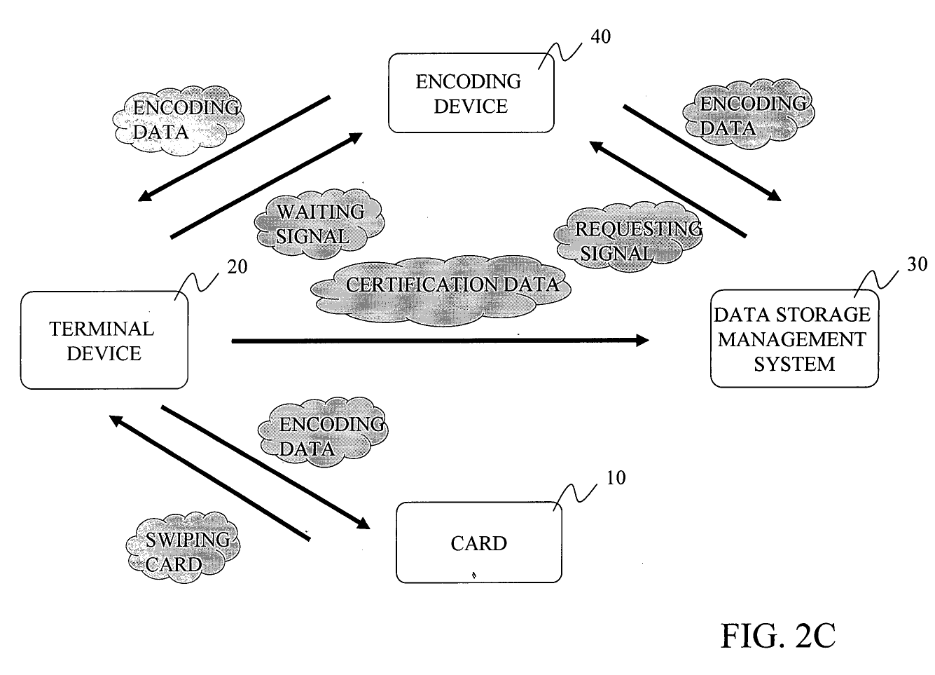

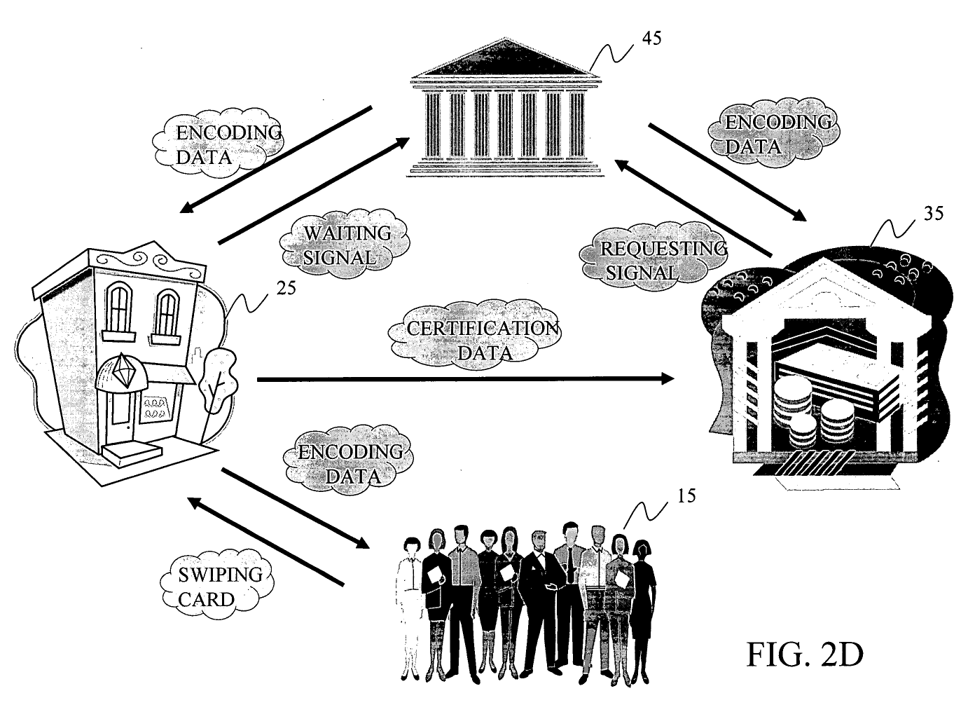

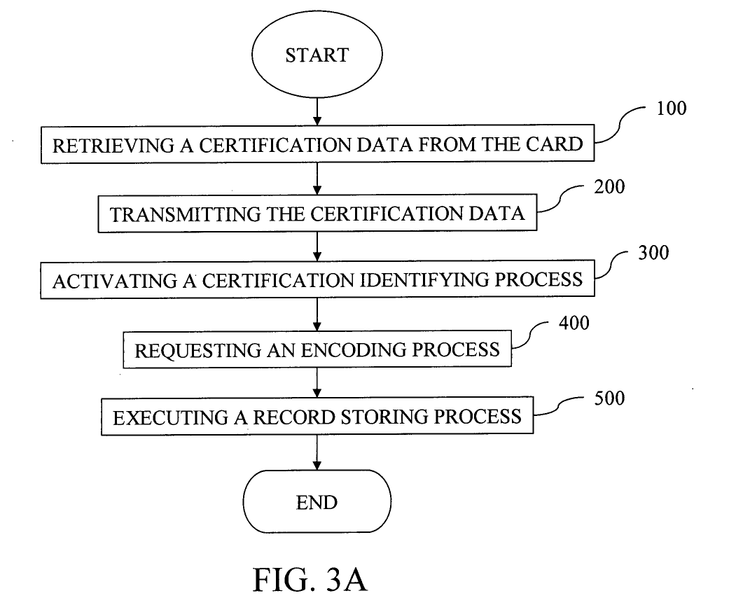

The following is an explanation of the invention's system and method for card certification and authorization process, referring to FIGS. 2a and 2b.

A major difference between the known procedure for card certification and authorization and this invention is that the invention uses an unbiased third party 45's encoding device 40 and produces the encoding data randomly. Each time when the card 10 completes the authorization process successfully, it uses the terminal device 20 and stores the encoding data that are different from the originals in the card 10, for later certification purposes. Therefore, the data storage management system 30, executes a bi-directional certification process, by comparing the encoding data, stored in the card 10, and the encoding data, stored in the database. A more detailed explanation of each building block of the system is included in the following.

The card 10, issued by the card issuer 35, contains a memory chip, i.e. an IC chip, which allows the reading and writing of data. The certification data stored in the memory chip include at least the card encoding data, sometimes even the commonly known card information cardholder such as the PIN number, and internal coding information such as the card issuer 35's issuing code. Normally, the card issuer 35 stores at least one card encoding figure in the card 10 when issued. This figure can also be produced by the unbiased third party 45's encoding device 40. The figures and content of the data are generated randomly. Therefore, every issued card 10 has different numbers with unique encoding data, and all the data are converted and encrypted before being stored in the database, and used later for certification and authorization purposes.

Terminal device 20, which is located at the card-swiping device 25, retrieves the certification information stored in the card 10 and transmits the information to the data management storage system 30 for comparison. It also sends a waiting signal to the encoding device 40, requesting the data storage management system 30 to anticipate the continual executing of the authorization procedures. The terminal device 20 transmits the encoding data back to the card 10 if the comparison by the data storage management system 30 is successful. If the comparison with the data storage management system 30 is unsuccessful, it uses the transmitted cancellation signal to terminate the authorization process, and executes the notification procedure, such as notifying the cardholder 15 and the connected units. The terminal device 20 includes devices such as card readers/writers, or card swiping devices. It may also consist of a clock and the capability of recording the storage time in the card 10, or image capturing devices, such as digital camcorders, or digital cameras, to record the instant images of the cardholder 15 for the notifying procedures.

A data storage management system 30, which is usually situated at the card issuer location 35, includes a database storing the encoding data. It also encodes, decodes and encrypts the encoding data. It uses the result of the comparisons for the encoding data stored in the card 10 to decide whether a requesting signal or a cancellation signal should be transmitted. The requesting signal is sent to the encoding device 40, requesting the production of the encoding data, and the cancellation signal is used by the data storage management system 30 to put the account on ‘hold’.

The code conversion, recovery and encryption programs are used during the retrieval and storage of the encoding data. They provide conversions for the logical and physical sequence number 650 and the encoding data's number of digits. The conversion procedure is an open and non-repeating random number generating process, done locally. Therefore, every encoding data's physical sequence number 650 same as the card 10's encoding data sequence, the encoding data's number of digits same as card 10's encoding data's number of digits, and the encoding data content will never be the same as the stored data's logical sequence number 610 in the database and the encoding data's number of digits. Usually the encoding data's conversion and encryption processes use data sheets or text files to record the relationship of each conversion process, such as the relationship of the logical and physical sequence numbers, the encoding data's number of digits and the encoding data's contents.

A data storage management system 30 compares the card encoding data and the original encoding data one-by-one to improve the efficiency of the certification and authorization process. The comparison process starts with the last entry, i.e. the latest entry, and moves forward.

Encoding device 40, which is usually situated at the unbiased third party 45 or the card issuer 35, needs to be independently operated from the data storage management system 30. It receives the waiting signal from the terminal device 20 and the requesting signal from the data storage management system 30. When the requesting signal is received, it starts producing codes random and stores them in the card 10. It also produces the encoding data in the data storage management system 6 30, and transmits encoding data back to the data storage management system 30.

The random encoding method includes the encoding data type such as the text and number symbols, the pictures, the images, the colors and the time, the encoding data's number of digits and the encoding data content's random selection order. It is also an open and non-repeating random number process.

Each system building block of the invention is connected to a network for sending data and signal-transmission. This can be a wired or wireless network. When each system building block needs to be connected in a wireless network, wireless connecting interfaces need to be added to allow operations.

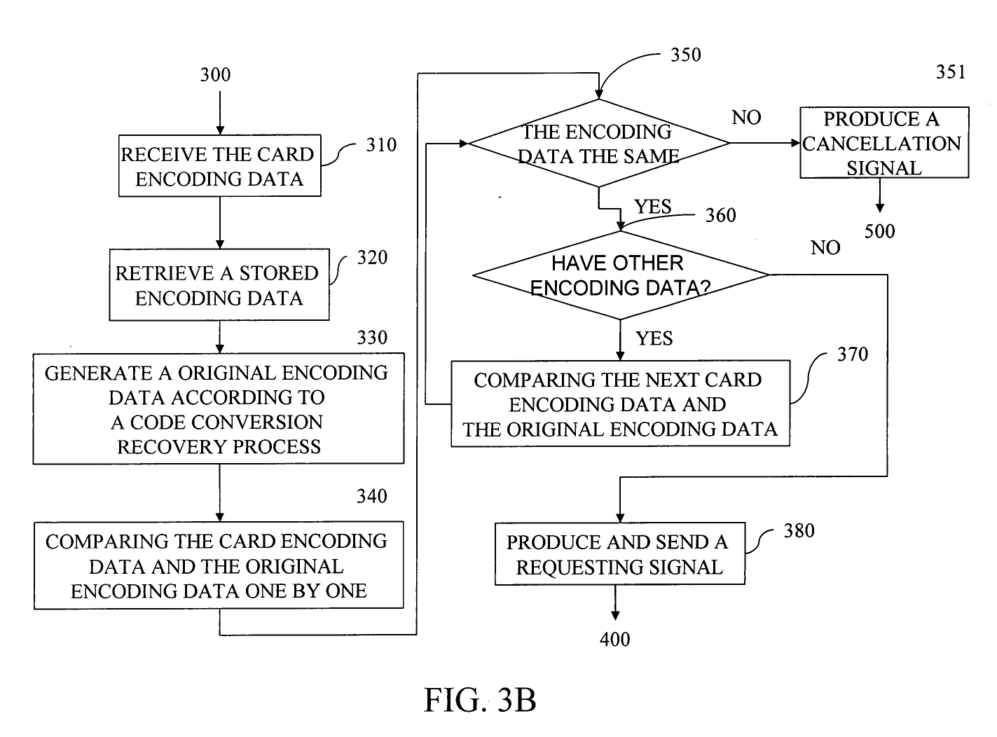

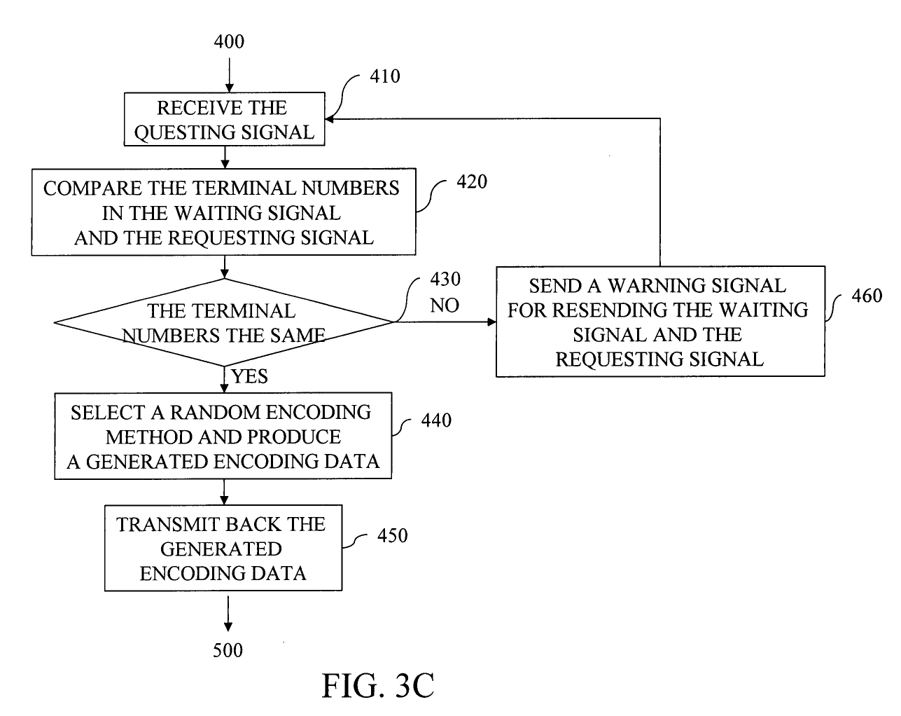

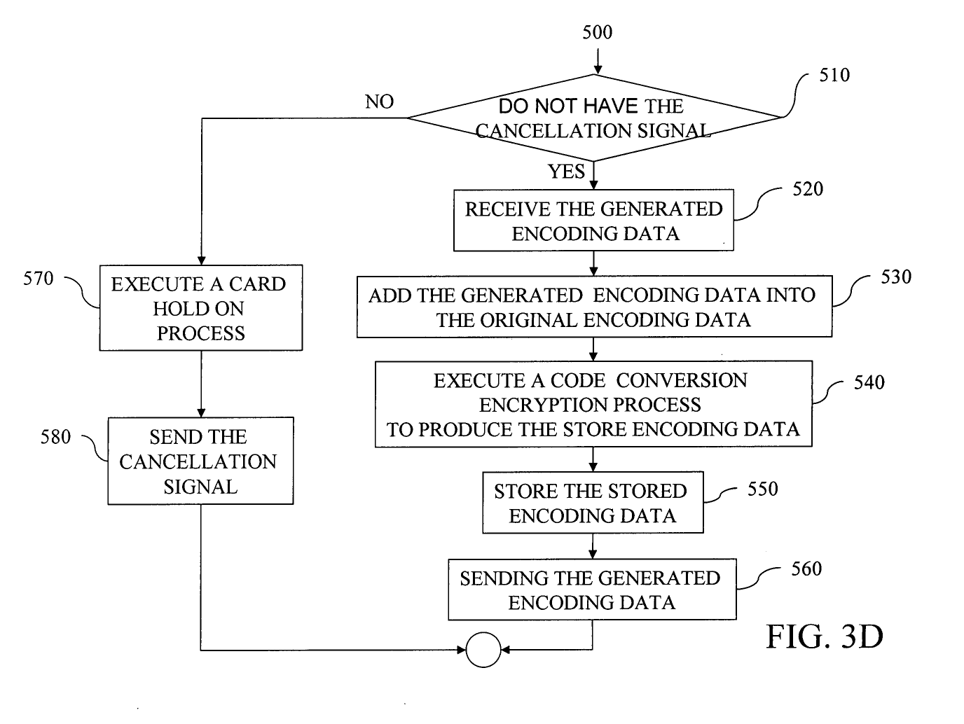

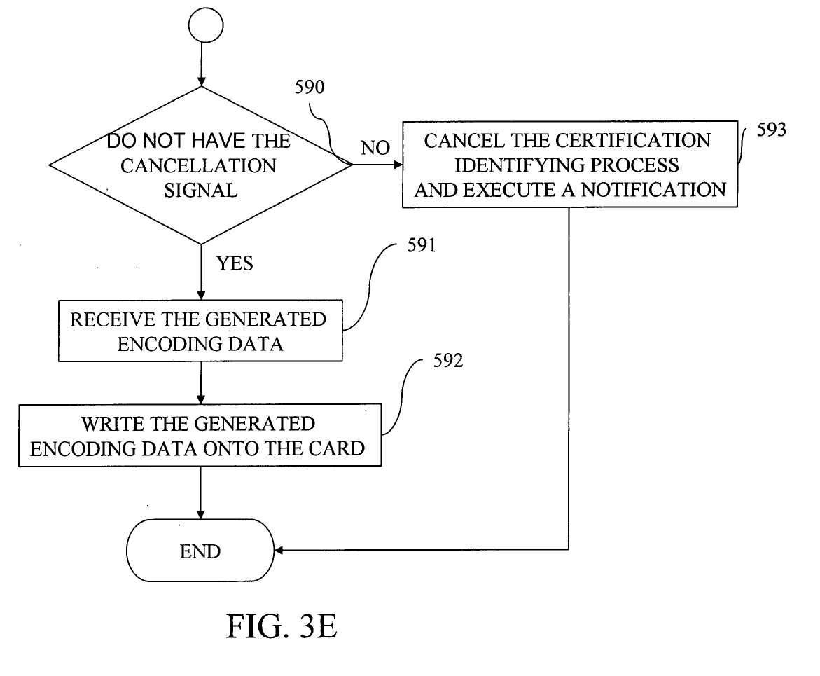

FIG. 3a illustrates the invention's card certification and authorization flow in a diagram and explains several of the major steps in the process. First, it uses the terminal device 20 to retrieve the certification data from the card 10 (step 100) and then transmits the certification data to the data storage management system 30 (step 200). It transmits the waiting signal, containing the terminal number, to the encoding device 40. Then the data storage management system 30 starts the certification identifying process step 300. When successful, the encoding device 40 starts the encoding process step 400. Last, the data storing procedure is executed through the data storage management system 30 and the terminal device 20. (step 500) The certification and authorization process is now completed.

FIG. 3b illustrates the details of the method of the invention for certification identifying process. FIG. 3c illustrates the details of the encoding process of the invention. FIGS. 3d and 3e illustrate the details of the storage process of the method of the invention.

When the cardholder 15 takes the card 10 to the card-swiping device 25 and swipes it, the terminal device 20 of the card-swiping device 25 retrieves the encoding data from the card 10 and transmits it to the data storage management system 30 of the card issuer 35 to start the authentication process. If it is the first time the cardholder 15 uses the card, then the initial encoding data stored in the card 10 will be used for the certification and authorization process. In fact, the invention can also verify the cardholder's information and internal coding data, stored in the card 10 during the certification and authorization process. However, it is a common technique used in authentication devices and is not emphasized by the invention, and will not be mentioned again. The data storage management system 30 first receives the card encoding data (step 310), which includes multiple records stored from previous certification and authorization processes. The data storage management system 30 then uses the card 10's cardholder information to retrieve the stored encoding data (step 320) from the database. Since the stored encoding data are converted and encrypted, a recovery process needs to be performed to retrieve the original encoding data (step 330). This means following the original code conversion and encrypting formula, the relationships of the physical sequence number and the encoding data's number of digits, to perform the reversing process obtaining the original data. The one-by-one comparison process with the card encoding data (the original encoding data) (step 340) starts at the last data entry, which are the latest data, moves forward and checks if the entries are the same (step 350). If any differences are discovered in the entries, a cancellation signal is produced (step 351) and then the flow goes to the data storing process. If the entries are the same, keep going to check other records to be compared (step 360). If the records are identical, then it determines if there are more records to be compared (step 370). If no more records need to be compared and the process is completed without finding any discrepancies, a requesting signal is transmitted to the encoding device (step 380). This ends the certification and authorization process.

When the requesting signal is generated, it means the invention is about to enter the encoding process, please use FIG. 3c as reference. The encoding system 40, which received the waiting signal from the terminal device 20 and remained in the waiting stage, now receives the requesting signal from the data storage management system 30 (step 410) and starts the encoding process. First, it compares the terminal numbers included in the waiting and the requesting signal (step 420) and determines if the terminal numbers are identical (step 430). If the terminal numbers are different, the encoding device 40 transmits separate warning signals for the terminal device 20 and the data storage management system 30 and requests verifications and the retransmission of the waiting and requesting signals (step 460). If the terminal numbers are identical, the encoding device 40 will choose a local encoding method to start encoding and produce the latest encoding data (step 440). The local encoding method is targeted at the encoding data type (such as text and number symbols, pictures, images, color or time), encoding data's number of digits, or the encoding data content's local selection order. The selection process is also an open and non-repetitive random number process. The generated encoding data is transmitted back to the data storage management system 30 (step 440). The encoding process is completed.

When the encoding process is completed or if the comparison result shows discrepancies, the invention enters the record storing process. There are two major components of the record storing process: the part executed by the data storage management system 30, shown in FIG. 3d, and the part executed by the terminal device 20, as shown in FIG. 3e.

First, before the data storage management system 30 starts the data storing process, it first determines if there is a cancellation signal (step 510). If there is a cancellation signal, it shows that there are questions regarding the legitimacy of the card 10. It then puts the card account on ‘hold’ (step 570), which terminates the card 10's usability and the right to redistribute, and records this condition. A cancellation signal is sent to the terminal device 20 (step 580) and the system enters step (590), which is executed by the terminal device 20 and explained later. If there is no cancellation signal, then the card does not have any legitimacy problems and receives the generated encoding data from the encoding device 40 (step 520). The generated encoding data are newly added and become part of the original encoding data (step 530), added to the end of the existing encoding data. To ensure the safety of the data in the database of the data storage management system 30, the original encoding data set undergoes code conversion and an encryption procedure. Then it receives the finally stored encoding data (step 540). The code conversion and encryption procedure also use a formula for code converting, recovering and encrypting for logical and physical sequence numbers, encoding data numbers of digits, and the content of the encoding data. After the code conversion and encryption, the resulting encoding data are stored in the database (step 550). The encoding data generated by the encoding device 40 are transmitted to the terminal device 20 (step 560) and then entering step 590. The portion executed by the terminal device 20 is explained in the following paragraph. This finishes the data storing procedure executed by the data storage management system 30.

Entering the portion executed by the terminal device 20, it will first be determined if there is a cancellation signal from the data storage management system 30 (step 590). If there is a cancellation signal, the authentication process will be cancelled and the necessary notification process will be executed (step 593). This includes: performing the notification process of the cardholder and the connected units, such as the law enforcement authority or the card issuer using the terminal device 20. Adding the image capturing equipments to the terminal device 20, such as digital camcorders and digital cameras, gives the possibility to obtain the instant images during the notification process. After notification, the record storing process and authorization flow will be terminated. If there is no cancellation signal, the authorization process is successful and the generated encoding data are produced. The terminal device 20 receives the generated encoding data from the data storage management system 30 (step 591), and writes the data in the memory chip of the card 10 (step 592). The record storing time can also be recorded in the memory chip for making the certification and authorization process more complete. The data storing process and the certification and authorization process is finished at this time.

The descriptions above are details of the invention of the system and method for card certification and authorization basic blocks and operation procedures. The invention can be set up using a wired or wireless network to perform the data and signal transmissions. Of course, the transmission method of the data and signals is not limited to the basic procedures mentioned above; it can be changed as long as it does not violate any basic system building block and basic operation flow, such as the encoding data produced by the encoding device 40: they can be directly transmitted to the terminal device 20, and do not have to go through the data storage management system 30 (shown in FIGS. 2c and 2d).

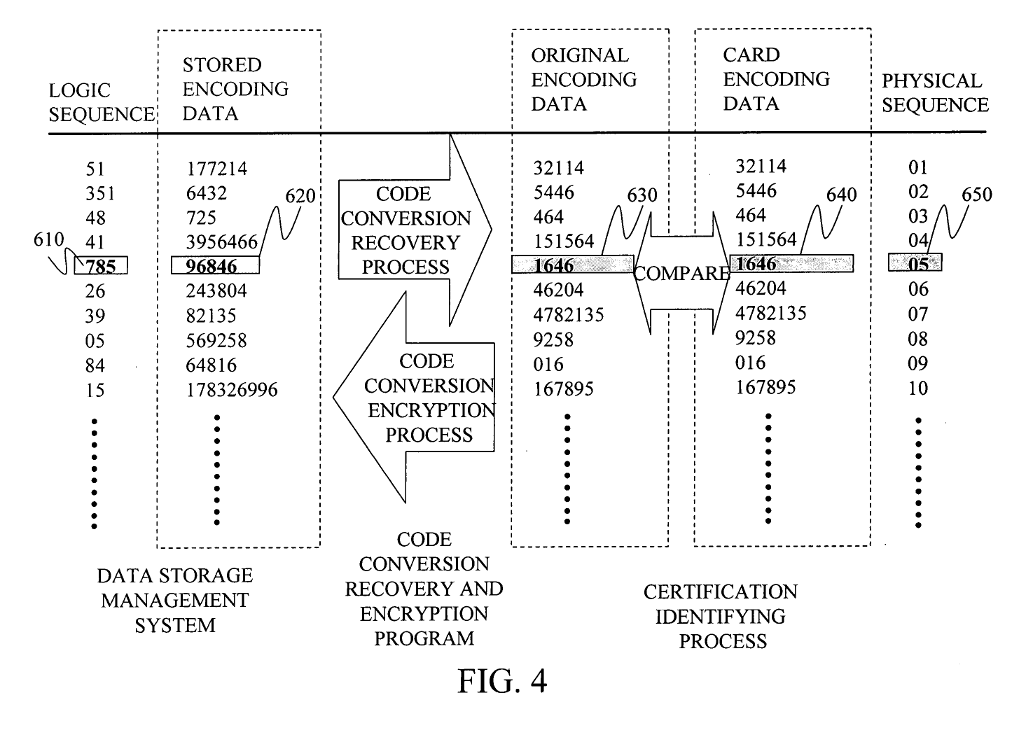

Last, using an embodiment, here is the explanation for the code conversion, recovery and encryption method used in this invention. Please use FIG. 4 as reference.

It was mentioned that when the encoding data are retrieved, a code recovery process is executed and when the encoding data are stored, there is an encryption process. Both of these conversion processes are open and non-repeating random number procedures, so each encoding data's physical sequence number 650 and encoding data's number of digits will always be different from the logical sequence number 610 or the encoding data's number of digits of the records in the database, as shown in FIG. 4. When the encoding data are retrieved, the stored encoding data from the database undergo a recovery process. The stored encoding data 620 numbers with logical sequence numbers 610 “785” is “96846”, is a five-digit number. It is converted back to the physical sequence number 650 “05” with the original encoding data 630 of “1646”, which is a four digit number. These data are compared with the card encoding data 640 in the sequence number “05” stored in the card 10. When the encoding data are encrypted, the original encoding data “1646” with “05” as its physical sequence number 650, are converted using the random number generated locally, to have another logical sequence number 610 and a stored encoding data content 620. To increase the security of the code conversion, recovery and encryption, the open and non-repeating local random process is used to produce the final stored encoding data 620. The stored encoding data 620, after the code recovery and encryption process, has a different logical sequence number 610, a different digit-number 620 and content from before. This reduces the risk of cracked and reproduced data.

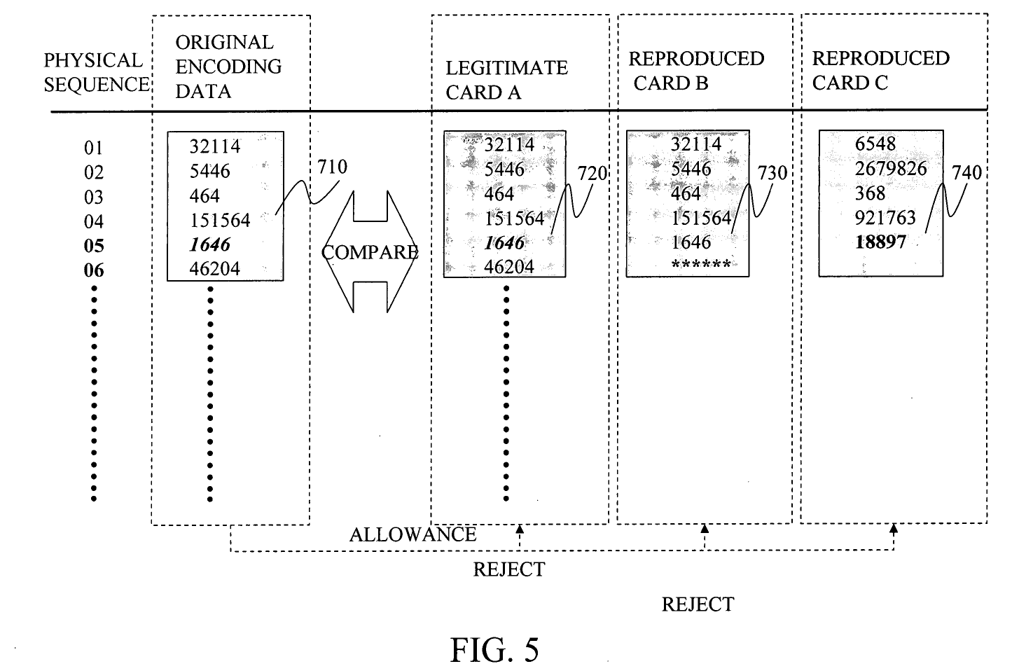

FIG. 5 illustrates the flow bidirectional certification and authorization process using an embodiment of the invention.

The card 10 can be reproduced into card B by recording information while the cardholder 15 is producing the encoding data of the physical sequence number “05”, or reproduced into card C by stealing internal database information. When the cardholder 15 completes the next authorization process, card A, the original card, produces the encoding data with physical sequence number “06”. Using the bi-directional certification and authorization process, the legitimate card A's encoding data content 720, the reproduced card B's encoding data content 730, and the reproduced card C's encoding data content 740 are compared with the original encoding data content 710. Card A's encoding data content 720 has complete original encoding data record and will be authorized. However, card B and C do not have the encoding data with physical sequence number “06” of “46204”, the card account will be put on hold and the authorization is denied. If the cardholder 15 has never used the card 10 after opening the account, the reproduced card C will also be discovered for having the converted and encrypted stored encoding data 740 of “18897” instead of the original encoding data content 710 of “1646”, so the authorization will be denied and the account put on hold. Using the terminal device 20 to record the data storage time onto the memory chip can also prevent the illegal use of the cards, to achieve the complete effect of the bi-directional certification and authorization.

For easy illustration purposes, the examples used above are numbers for representation. The invention is applicable to different encoding types, such as text and number symbols, pictures, images, colors, and time, to execute random number encoding for the number of digits of the encoding data.

Understanding the invention being thus described, it will be obvious that the same may be varied in many ways. Such variations are not to be regarded as a departure from the spirit and scope of the invention, and all such modifications, obvious to one skilled in the art, are intended to be included within the scope of the following claims.

What is claimed is:

1. A card certification and authorization system, which executes instantaneous bi-directional comaprisons during the certification and authorization processs of a card, providing a safe certification and authorization process, comprising:
a card, which comprises a memory chip that has read and write functions, that stores a card certification data;
a data storage management system, which comprises a database storing the encoding data and a conversion, recovery, and encryption program for recovering and encrypting the encoding data, uses the results of the comparisons according to the encoding data stored in the card to produce a requesting signal or cancellation signal, and put the account on hold according to the cancellation signal;
a encoding device, which is used to receive the requesting signal, for generating the encoding data that will be recorded on the card and the data storage management system randomly, and responsible for transmiting the encoding data back; and
a terminal device, which retrieves the certification data stored on the card, for writing the encoding data onto the card or executing a cancellation process then notifying authority according to the cancellation signal;
wherein the card, a terminal device, encoding device and data storage management system are all connected to a network for data and signal transmissions.

2. The card certification and authorization system of claim 1, wherein the card certification data includes at least one set of card encoding data.

3. The card certification and authorization system of claim 2, wherein the card certification data futher comprises a cardholder's information and a coding data.

4. The card certification and authorization system of claim 1, wherein when the card is initialized, it includes at least one set of predetermined card encoding data using the random encoding method.

5. The card certification and authorization system of claim 1, wherein the data storage management system futher comprises the certification of the cardholder information and coding data.

6. The card certification and authorization system of claim 1, wherein the data storage management system's comparisons of the card encoding data start with the last record.

7. The card certification and authorization system of claim 1, wherein the code conversion, recovery and encryption program can provide the encoding data a logical, physical sequence number and encoding data's number of digits conversion.

8. The card certification and authorization system of claim 7, wherein the logical and physical sequence number and the encoding data's number of digits are produced using an open and non-repeating random number process.

9. The card certification and authorization system of claim 1, wherein the random encoding method comprises the encoding data type, encoding data's number of digits, and the encoding data content using the open and non-repeating random selection.

10. The card certification and authorization system of claim 9, wherein the encoding data type is one selected from the group consisting of text and number symbols, pictures, images, colors, and time.

11. The card certification and authorization system of claim 1, wherein the terminal device is a read and write card machine.

12. The card certification and authorization system of claim 1, wherein the terminal device is a card swiping machine.

13. The card certification and authorization system of claim 1, wherein the terminal device futher comprises an image capture device for capturing the instant image to transmit for the notification process.

14. The card certification and authorization system of claim 1, wherein the terminal device futher cpmprises a timer for recording time onto the card.

15. The certified card authentication system of claim 1, wherein the notification process notifies at least the cardholder or a connected authority.

16. The card certification and authorization system of claim 1, wherein the network compises a wired network or a wireless network.

17. The ccard certification and authorization system of claim 1, wherein the system futher comprises a wireless network module at the card, the terminal device, the encoding device, and the data storage management system respectively to allow for data and signal transmissions via the wireless network connection.

18. A card certification and authorization method, which executes instantaneous bi-directional comaprisons during the certification and authorization processs of a card, providing a safe certification and authorization process, comprising the following steps:
obtaining the card certification data from the card via a terminal device;
transmitting the card certiffication data to a data storage management system;
initiating a certification identifying process by the data storage management system;
requesting an encoding process vai an encoding device; and
executing a record storage process via the data storage management system and the terminal device.

19. The card certification and authorization method of claim 18, wherein the method uses a network to transmits data and signals.

20. The card certification and authorization method of claim 19, wherein the network comprises at least a wired or a wireless network.

21. The card certification and authorization method of claim 18, wherein the card certification data comprises at least a card encoding data.

22. The card certification and authorization method of claim 21, wherein the card certification data futher comprises a cardholder information and a coding data.

23. The card certification and authorization method of claim 18, wherein when the card is initialized, it comprises at least one record of the predetermined card encoding data produced by a random encoding method.

24. The card certification and authorization method of claim 18, wherein the step of transmission of the card certificaiton data to the data storage management system futher copmprises a step of transmitting a waiting signal to the encoding device.

25. The card certification and authorization method of claim 24, wherein the waiting signal comprises at least one terminal number.

26. The card certification and authorization method of claim 18, wherein the step of the data storage management system initializing the certification identifying process comprises the following:
receiving the card encoding data;
retrieving a stored encoding data;
producing an original encoding data according to a code conversion recovery process;
comparing the card encoding data and the original encoding data one-by-one; and
producing a requesting signal when all the encoding data are identical.

27. The card certification and authorization method of claim 26, wherein the code conversion and recovery process converts the stored encoding data back to the original encoding data according the correspondent relationship between the pre-recorded logical and physical sequence number and the encoding data's number of digits to.

28. The card certification and authorization method of claim 26, wherein the step of initiating the certification identifying process by the data storage management system futher comprises a step of generating a cancellation signal when the comparison of the encoding data by the data storage management system shows discrepancy.

29. The card certification and authorization method of claim 26, wherein the step initiating the certification identifying process by the data storage management system comprises a step of comparison of the cardholder information and the coding data by the data storage management system.

30. The card certification and authorization method of claim 26, wherein the step of comparing the card encoding data and the original encoding data one-by-one starts with the last data entry.

31. The card certification and authorization method of claim 26, wherein the requesting signal comprises at least the terminal number.

32. The card certification and authorization method of claim 18, wherein the step of requesting an encoding process vai an encoding device further comprises the steps of:
receiving the requesting signal;
comparing the terminal numbers included in the waiting signal and the requesting signal;
producing an encoding data using the selected random encoding method when the terminal numbers are the same; and
transmiting back the encoding data.

33. The card certification and authorizationn method of claim 32, wherein the random encoding method comprises the encoding data type, encoding data's number of digits, and the encoding data content using the open and non-repeating random selection.

34. The card certification and authorization method of claim 33, wherein the encoding data type is one selected from the group consisting of text and number symbols, pictures, images, colors and time.

35. The card certification and authorization method of claim 32, wherein said the step of requesting an encoding process vai an encoding device further comprises the steps of a step of the transmission of the warning signal for requesting the retransmission of the waiting signal and the requesting signal when the encoding device discover differences between the terminal numbers.

36. The card certification and authorization method of claim 18, wherein the step of executing a record storage process via the data storage management system comprises the steps:
receiving the generated encoding data;
adding the generated encoding data to the original encoding data;
executing the code conversion and encryption process to produce the stored encoding data;
saving the stored encoding data again; and
transmitting back the produced encoding data.

37. The card certification and authorization method of claim 36, wherein the code conversion and encryption process converts the logical and physical sequence number and the encoding data's number of digits according to an open and non-repeating random method.

38. The card certification and authorization method of claim 36, wherein the step of executing a record storage process via the data storage management system further comprises a step of when the data storage management system receives the cancellation signal, puting the account on hold and transmiting the cancellation signal.

39. The card certification and authorization method of claim 18, wherein the step of executing a record storage process via the ternimal device further comprises steps of:
receiving the generated encoding data; and
writing the generated encoding data onto the card.

40. The card certification and authorization method of claim 39, wherein the step of executing a record storage process via the ternimal device further comprises a step of notification and termination of the certification identifying process when the terminal device receives a cancellation signal.

41. The card certification and authorization method of claim 40, wherein the notification process comprises a step of at least notify the cardholder and a connected unit.

42. The ard certification and authorization method of claim 40, wherein the notification process comprises a step of capturing of an instant images by the terminal device and transmitting the image during the notification process.

43. The ard certification and authorization method of claim 39, wherein the step of writing the generated encoding data onto the card compriese a step of writing a record time onto the card.
